(19) United States
(12) Patent Application Publication
(10) Pub. No.: US 2008/0297473 A1
(43) Pub. Date: Dec. 4, 2008

(54) POINTING DEVICE AND POINTING METHOD

(75) Inventor: Hisashi Mogi, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/130,366

(22) Filed: May 30, 2008

(30) Foreign Application Priority Data
May 31, 2007 (JP) 2007-145356

(51) Int. Cl. G06F 3/033

(52) U.S. Cl. 345/157

(57) ABSTRACT

According to one embodiment, there is provided a pointing device including a camera section which receives video light and outputs a video signal, a switch section which outputs an operation signal according to an operation, a detecting section which compares the video signal at first time supplied from the camera section with the video signal at second time different from the first time according to timing represented by the operation signal from the switch section so as to detect a moving vector showing a shift between the video at the first time and the video at the second time, and a control section which execute a predetermined process according to the moving vector detected by the detecting section.

### CROSS-REFERENCE TO RELATED APPLICATIONS

This application is based upon and claims the benefit of priority from Japanese Patent Application No. 2007-145356, filed May 31, 2007, the entire contents of which are incorporated herein by reference.

### BACKGROUND

1. Field

One embodiment of the invention relates to a pointing device and a pointing method which use a change in a video signal from a camera.

2. Description of the Related Art

In recent years, with the development of a digital video technique, video processing apparatuses for mobile telephones and digital contents can easily execute video processes. In such video processing apparatuses, many techniques for carrying out pointing input on a display screen are known.

Jpn. Pat. Appln. KOKAI Publication No. 2001-166881 discloses a highly operable, small and lightweight pointing device and a pointing method which enable a pointer display operation and a command executing operation on a display screen from any operation position.

However, in the conventional technique in above document, pointing means is prepared to execute writing on an object so as to specify the object. Therefore, it tends to be difficult to specify an object in a far place which is desired to be specified. Further, when independent pointing means such as write and direction keys, a touch pad and a touch panel are prepared, the cost becomes high and management becomes bothersome.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram illustrating one example of a structure of a pointing device according to one embodiment of the present invention;

FIG. 2 is a flow chart illustrating one example of a pointing operation using a track of a pointer in the pointing device according to one embodiment of the present invention;

FIG. 3 is a flow chart illustrating one example of a pointing operation using a start point and an end point of the pointer in the pointing device according to one embodiment of the present invention;

FIGS. 4A and 4B are explanatory diagrams illustrating one example of the pointing operation by means of a track of the pointer in the pointing device according to one embodiment of the present invention;

FIGS. 5A and 5B are explanatory diagrams illustrating one example of the pointing operation by means of the start point and the end point of the pointer in the pointing device according to one embodiment of the present invention;

FIGS. 6A and 6B are explanatory diagrams illustrating the pointing operation of a pointer region only in one direction in the pointing device according to one embodiment of the present invention;

FIGS. 7A and 7B are explanatory diagrams illustrating one example of the pointing operation by means of a pushing-down time of a switch in the pointing device according to one embodiment of the present invention;

FIG. 8 is an outline view illustrating one example of an outline of a portable communication device using the pointing device according to one embodiment of the present invention; and

FIG. 9 is a block diagram illustrating one example of a structure of a portable communication device using the pointing device according to one embodiment of the present invention.

### DETAILED DESCRIPTION

Various embodiments according to the invention will be described hereinafter with reference to the accompanying drawings. In general, according to one embodiment of the invention, there is provided a pointing device which executes a pointing process on an image easily using less onerous equipment.

One embodiment for achieving the object is a pointing device comprising:

a camera section (14) which receives video light and outputs a video signal;

a switch section (16) which outputs an operation signal according to an operation;

a detecting section (15) which compares the video signal at first time supplied from the camera section with the video signal at second time different from the first time according to timing represented by the operation signal from the switch section so as to detect a moving vector showing a shift between the video at the first time and the video at the second time; and

a control section (11) which execute a predetermined process according to the moving vector detected by the detecting section.

As a result, the pointing process can be executed on a screen showing image information easily without particularly adding a hardware structure for pointing.

An embodiment of the present invention will be described in detail below with reference to the drawings.

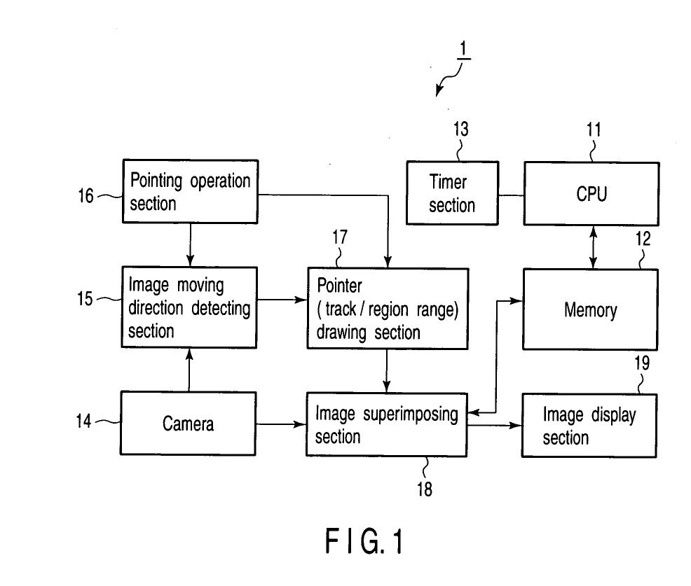

FIG. 1 is a block diagram illustrating one example of a structure of a pointing device according to one embodiment of the present invention.

<Pointing Device according to One Embodiment of the Present Invention>

(Structure)

One example of a structure of the pointing device according to one embodiment of the present invention will be described. A pointing device 1 according to one embodiment of the present invention has, as shown in FIG. 1, a CPU 11 which controls all operations, a memory 12 which is connected to the CPU 11, and a timer section 13 which counts elapsed time from a switching operation of a pointing operation section 16, for example.

Further, the pointing device according to one embodiment of the present invention has a camera 14, an image moving direction detecting section 15, the pointing operation section 16 such as a switch, a pointer (track/region range) drawing section 17, an image superimposing section 18, and an image display section 19 such as a liquid crystal display. The camera 14 receives video light and outputs a video signal. The image moving direction detecting section 15 detects a change in the video signal. The pointing operation section 16 inputs timing of pointing. The pointer drawing section 17 receives a compared result supplied from the image moving direction detecting section 15 so as to draw a track and a region range according to a moving vector on a screen. The image superimposing section 18 superimposes the track and region range on a video screen from the camera.

The pointing device 1 having such a structure is a portable communication device or the like, mentioned later, but it is not limited to this, and may be any device which treats a video signal and carries out pointing input.

(One Example of a Pointing Operation on the Video Screen in the Pointing Device)

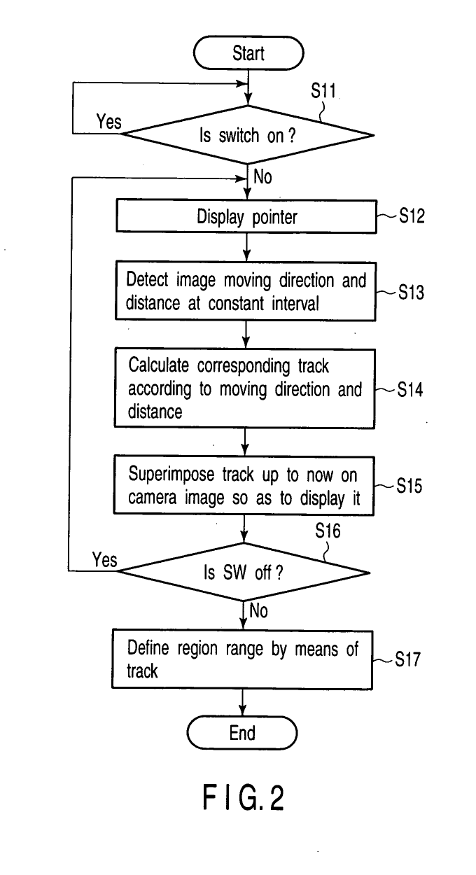

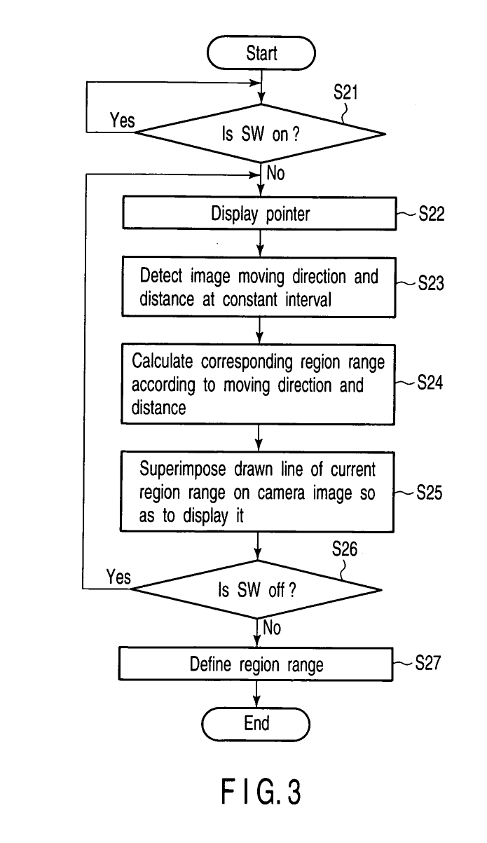

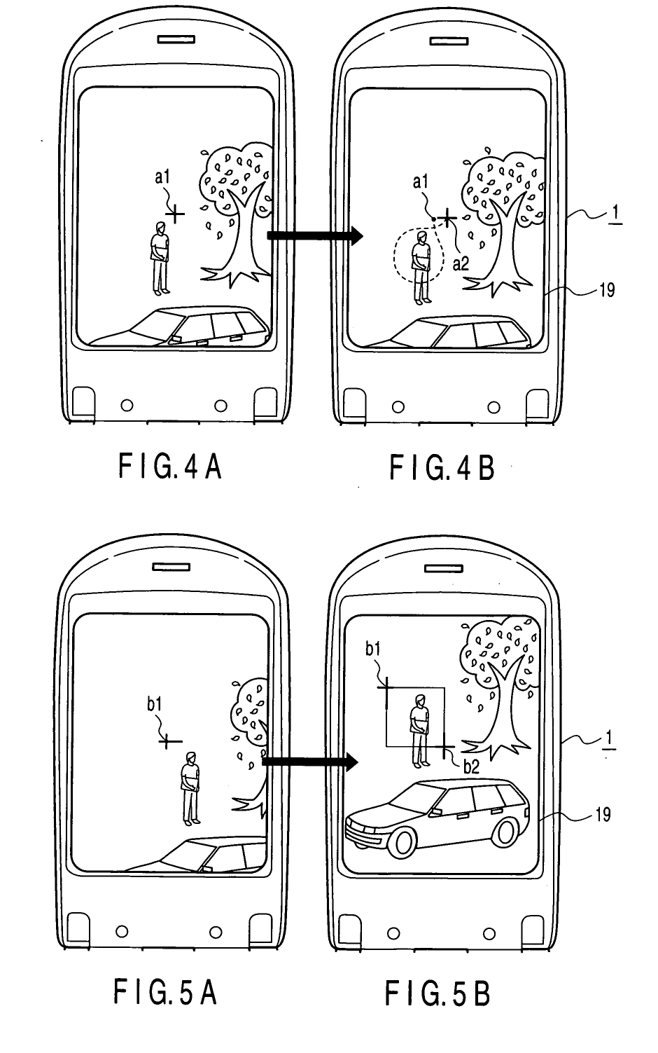

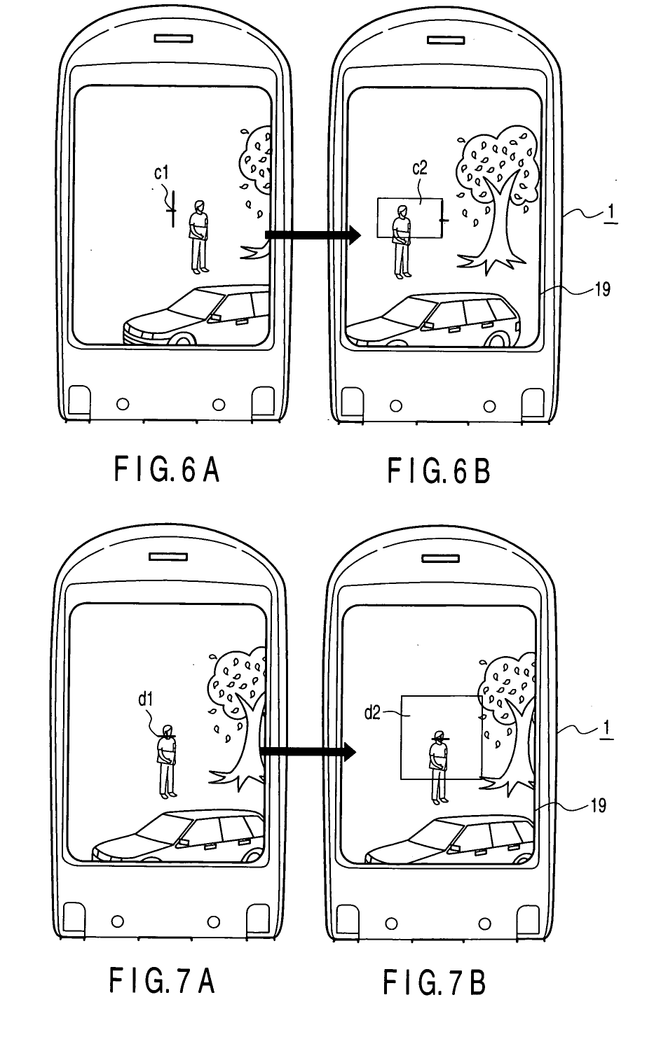

One example of the pointing operation on the video screen in the pointing device will be descried in detail below with reference to the flow charts and the explanatory diagrams. FIG. 2 is a flow chart illustrating one example of the pointing operation using a pointer track of the pointing device according to one embodiment of the present invention. FIG. 3 is a flow chart illustrating one example of the pointing operation using a start point and an end point of the pointer. FIGS. 4A and 4B are explanatory diagrams illustrating one example of an input process on pointing information by means of the pointer track. FIGS. 5A and 5B are explanatory diagrams illustrating one example of the pointing operation by means of a start point and an end point of the pointer. FIGS. 6A and 6B are explanatory diagrams illustrating one example of the pointing operation only in one direction in a pointer region. FIGS. 7A and 7B are explanatory diagrams illustrating one example of a pointing information input process by means of a switch pushing-down time.

The Pointing Operation by means of Track of the Moving Vector (FIGS. 2, 4A and 4B)

The pointing operation by means of a track of the moving vector will be described below with reference to the flowchart in FIG. 2.

Steps in the flow charts in FIGS. 2 and 3 can be replaced with circuit blocks, and thus all the steps in the flow charts can be redefined as blocks.

In the pointing device 1 according to one embodiment of the present invention, as shown in the flow chart in FIG. 2, after a mode for accepting the pointing operation is set, the CPU 11 receives an on-operation signal from the switch or the like of the pointing operation section 16 (step S11), and allows a pointer to appear on the screen of the image display section 19 by means of the pointer (track/region) drawing section 17 and the image superimposing section 18 (step S12).

The image moving direction detecting section 15 compares a video signal from the camera 14 every constant time (for example, every 0.1 second) on each screen, and detects a change in the video captured by the camera 14 as a moving vector (size and direction) (step S13). The pointer drawing section 17 receives a moving vector signal from the image moving direction detecting section 15 so as to calculate a track (step S14). The pointer drawing section 17 then superimposes the track of the pointer from a start point a1 to an end point a2 on a video screen from the camera as shown in FIG. 4B so as to display it (step S15).

Such a process continues until the switch or the like of the pointing operation section 16 is turned off. When the switch is turned off (step S16), the CPU 11 and the pointer drawing section 17 allow the image superimposing section 18 to superimpose the image of the track, whose region range is defined, on the video screen from the camera 14 (step S17). In this case, a closed curve having an infinite form other than a rectangular form can be formed by the track of the pointer. However, the CPU 11 and the pointer drawing section 17 may specify a rectangle corresponding to a predetermined region, which is represented by set maximum value and minimum value in a horizontal direction and set maximum value and minimum value in a vertical direction as coordinates shown by the track of a moving vector.

Therefore, a user watches the screen displayed on the image display section 19 and simultaneously tilts an angle of the camera 14 to suitably shift a video, so as to be capable of performing the pointing operation on a desired region on the screen specified by the track according to the moving vector.

Thereafter, the CPU 11 and the memory 12 executes a predetermined process according to the region range defined by the track. The predetermined process may be to store a video in the region range into the video memory 12 or to enlarge a video in the region range, and various video process can be executed. The CPU 11 and the memory 12 preferably store a video in the region range, detect the video in the region range from the video signal from the camera 14, and execute a marking process on the screen so as to track a target.

According to the pointing device in this embodiment, the fine pointing operation is enabled only by preparing the switch for giving timing as a device without using a touch panel or a touch pad.

In another method, according to operation programs in the CPU 11 and the memory 12, the function of the camera is turned off at times other than the time when the switch of the pointing operation section 16 is turned on. As a result, the pointing operation can be preferably executed while suppressing power consumption.

The Pointing Operation by means of Part of the Moving Vector (FIGS. 3, 5A, 5B, 6A, 6B, 7A and 7B)

The pointing operation by means of a part of the moving vector will be described below with reference to the flow chart in FIG. 3. In the pointing device 1 according to one embodiment of the present invention, as shown in the flow chart of FIG. 3, after a mode for accepting the pointing operation is set, when the CPU 11 receives an on-operation signal from the switch of the pointing operation section 16 (step S21), it uses the pointer (track/region) drawing section 17 and the image superimposing section 18 to make the pointer to appear on the screen of the image display section 19 (step S22). The image moving direction detecting section 15 compares video signals from the camera 14 for each screen every constant time (for example, every 0.1 second), so as to detect a change in the video captured by the camera 14 as the moving vector (size and direction) (step S23).

The pointer drawing section 17 receives the moving vector signal from the image moving direction detecting section 15, and calculates a region range based on the moving direction and distance shown by the moving vector signal as shown in FIG. 5 or 6 (step S24). The pointer drawing section 17 superimposes a drawn line of the region specified by a start point b1 and an end point b2 on the video screen from the camera so as to display it as shown in FIG. 5B (step S25). In FIG. 5B, the rectangle specified by the start point b1 and the end point b2 becomes the region. However, the region may preferably have not only the rectangle shape but also a circular or oval shape.

The pointer drawing section 17 superimposes a drawn line of a region specified by a start point c1 and an end point c2 on the video screen from the camera so as to display it as shown in FIG. 6B (step S25). In FIG. 6B, a length in the vertical direction does not change, but only a length in the horizontal direction changes.

Such a drawing process continues until the switch of the pointing operation section 16 is turned off. When the switch is turned off (step S26), the CPU 11 and the pointer drawing section 17 allow the image superimposing section 18 to superimpose a track image, whose region range by the moving vector is defined, on the video screen from the camera 14 and display it (step S27). The CPU 11 and the pointer drawing section 17 preferably specify a rectangle of a predetermined region represented by a maximum value and a minimum value in a horizontal direction and a maximum value and a minimum value in a vertical direction of the moving vector by means of setting instead of coordinates of the start point and the end point of the moving vector.

Therefore, the user watches a screen displayed on the image display section 19 and simultaneously tilts the angle of the camera 14 so as to suitably shift a video. As a result, the pointing operation can be performed on a desired region on the screen specified by the moving vector.

Similarly, the CPU 11 and the pointer drawing section 17 suitably specify a region in such a manner that a region d1 is enlarged in proportion to elapsed time from the timing when the switch of the pointing operation section 16 is turned on, the enlargement is stopped at timing when the switch is turned off, and a region d2 is specified as shown in FIG. 7.

Thereafter, the CPU 11 and the memory 12 execute a predetermined process according to the region range defined by a track. In the predetermined process, a video in the region range may be stored in the memory 12 or may be enlarged, and thus various video processes can be executed. The CPU 11 and the memory 12 store the video in the region range, and detect the video in the region range from the video signal from the camera 14, so as to execute a marking process on the screen. In such a manner, the target is suitably tracked.

According to the pointing device in this embodiment, the fine pointing operation can be performed only by preparing the switch for giving timing as the device without using a touch panel or a touch pad.

(Constitution and Operation of Portable Communication Device using the Pointing Device)

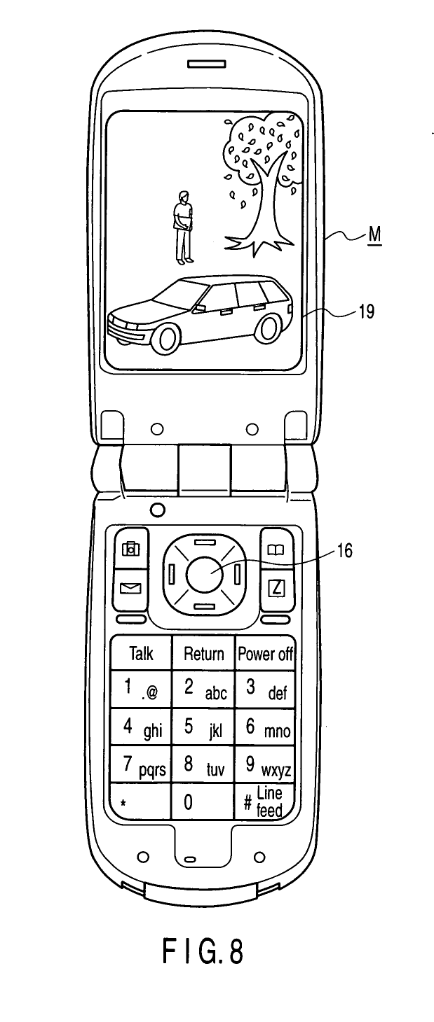

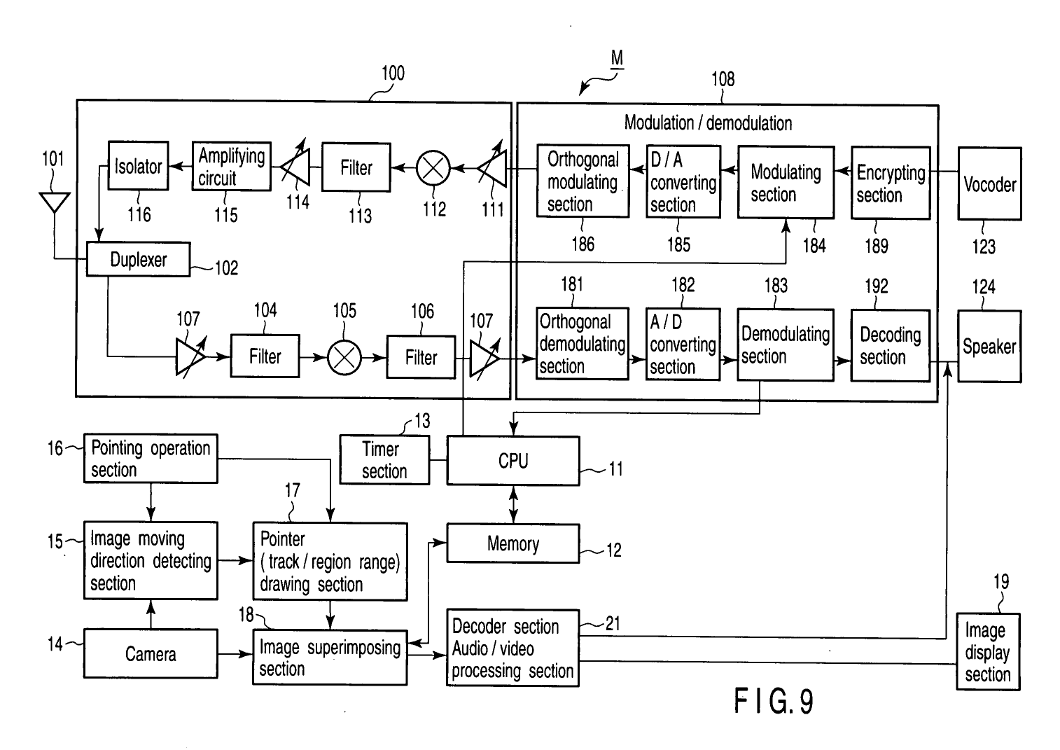

A case where the pointing device is applied to the portable communication device will be described as one example with reference to the drawings. FIG. 8 is a outline view illustrating one example of the portable communication device using the pointing device according to one embodiment of the present invention. FIG. 9 is a block diagram illustrating one example of a constitution of the portable communication device using the pointing device according to one embodiment of the present invention.

One example of the constitution of the portable communication device to which the pointing device is applied according to one embodiment of the present invention will be described. The portable communication device M according to one embodiment of the present invention has an outline shown in FIG. 8, and includes a vocoder 123 with which a user inputs audio, and a speaker 124 which the user holds to user's ears to listen to the audio. The portable communication device M can communicate with two or more mobile phones. Its details will be described later.

The portable communication device M has, as shown in FIG. 2, the CPU 11 which controls all the operations, the memory 12 which is connected to the CPU 11 and the timer section 13 which counts elapsed time from the operation of the switch of the pointing operation section 16.

The portable communication device (mobile phone) M according to one embodiment of the present invention further has the camera 14, the image moving direction detecting section 15, the pointing operation section 16 such as the switch, the pointer (track/region range) drawing section 17, the image superimposing section 18, the image display section 19 such as a liquid crystal display and a decoder/audio vide processing section 21. The camera 14 receives video light and outputs a video signal. The image moving direction detecting section 15 detects a change in the video signal. The pointing operation section 16 inputs timing of the pointing. The pointer drawing section 17 receives a compared result supplied from the image moving direction detecting section 15 so as to draw a track and region range according to a moving vector on the screen. The image superimposing section 18 superimposes the track and region range on a video screen from the camera. The decoder/audio video processing section 21 decodes an image and an audio signal so as to execute an audio/video process.

The portable communication device (mobile phone) M has an outline shown in FIG. 8 as one example, and includes a communication section 100, an antenna 101, a duplexer 102, an RF reception gain variable amplifier 103, an RF band limiting filter 104, a frequency converter 105, an IF band limiting filter 106, an IF reception gain variable amplifier 107, a modulating/demodulating section 108, an IF transmission gain variable amplifier 111, a frequency converter 112, an RF band limiting filter 113, an RF transmission gain variable amplifier 114, a power amplifier 115, an isolator 116, the vocoder 123, and the speaker 124 as shown in FIG. 9.

The modulating/demodulating section 108 is composed of, for example, an orthogonal demodulating section 181, an A/D converting section 182, a demodulating section 183, a decoding section 192, an encrypting section 189 which encrypts a signal from the vocoder 123, an information signal modulating section 184, a D/A converting section 185 and an orthogonal modulating section 186. In this constitution, the signal which is orthogonally demodulated by the orthogonal demodulating section 181 is A/D converted by the A/D converting section 182, is demodulated into an information signal by the demodulating section 183, and is decoded by the decoding section 192 so as to be output.

In the receiving process of the portable communication device M having such a constitution, a forward link signal transmitted from a base station is received by the antenna 101, is supplied to a receiver side circuit by the duplexer 102, and is amplified or attenuated by the RF reception gain variable amplifier 103. Further, an unnecessary component of the signal is filtered by the RF band limiting filter 104, the frequency is converted from the RF band into an IF band by the frequency converter 105, and an unnecessary component is filtered by the IF band limiting filter 106. The signal is then amplified or attenuated by the IF reception gain variable amplifier 107, and is input into the modulating/demodulating section 108.

The modulating/demodulating section 108 is composed of, for example, the orthogonal demodulating section 181, the A/D converting section 182, the demodulating section 183, the information signal modulating section 184, the D/A converting section 185, and the orthogonal modulating section 186.

The encrypting section 189 and the decoding section 192 preferably carry out encryption and decoding using common encryption key information, and prevent improper eavesdropping of communicated audio information according to the encrypting process. Strictly speaking, the encryption key information for encrypting from a mobile communication section on the transmission side and key information of the decoding section 192 on the reception side need to be common.

The receiving process of the portable communication device M having such a constitution will be described. According to the display of the operation information on a display section 134 given from a user's operating section 133, the following operation is performed under operation control of a control section 131. That is, a signal which is orthogonally demodulated by the orthogonal demodulating section 181 is A/D converted by the A/D converting section 182, is demodulated into an information signal by the demodulating section 183, and is decoded by the decoding section 192 so as to be output as audio to the speaker 124.

The transmitting process of the portable communication device M will be described below. Similarly, according to the display of the operation information given from the user's operation section 133 on the display section 134, the following operation is performed under operation control of the control section 131. That is, a reverse link signal transmitted from a mobile station is given by the vocoder 123, and is encrypted by the encrypting section 189. The encrypted signal is modulated by the information signal modulating section 184 and is output, and is D/A converted by the D/A converting section 185, is orthogonally modulated by the orthogonal modulating section 186, and is amplified or attenuated by the IF transmission gain variable amplifier 111. The frequency is converted from an IF band into an RF band by the frequency converter 112, an unnecessary component is filtered by the RF band limiting filter 113, and the signal is amplified or attenuated by the RF transmission gain variable amplifier 114. The signal is then amplified by the power amplifier 115, and is supplied to the antenna 101 via the isolator 116 by the duplexer 102 so as to be transmitted into air.

In the portable communication device M, the image moving direction detecting section 15 compares video signals from the camera 14 at the timing of the switch of the pointing operation section 16 every predetermined time so as to detect the moving vector. The fine pointing process can be executed on the screen of the image information easily by using the moving vector without especially adding a hardware structure (touch panel or touch pad) for pointing.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A pointing device comprising:
a camera section which receives video light and outputs a video signal;
a switch section which outputs an operation signal according to an operation;
a detecting section which compares the video signal at first time supplied from the camera section with the video signal at second time different from the first time according to timing represented by the operation signal from the switch section so as to detect a moving vector showing a shift between the video at the first time and the video at the second time; and
a control section which execute a predetermined process according to the moving vector detected by the detecting section.

2. The pointing device according to claim 1, wherein the detecting section detects a track of the moving vector based on the comparison of the video signals, and the control section executes the predetermined process according to the track of the moving vector detected by the detecting section.

3. The pointing device according to claim 1, wherein the detecting section specifies a predetermined region according to position information shown by the moving vectors at start time and end time of the timing represented by the operation signal from the switch section.

4. The pointing device according to claim 1, wherein the detecting section specifies a predetermined region shown by a maximum value and a minimum value in a horizontal direction and a maximum value and a minimum value in a vertical direction of the moving vector based on the comparison of the video signals.

5. The pointing device according to claim 1, wherein the detecting section specifies a predetermined region where one of the lengths in the horizontal and vertical directions of the moving vector based on the comparison of the video signals is changed and the other length is fixed.

6. The pointing device according to claim 1, wherein the detecting section specifies a range determined according to elapsed time from start time to end time of the timing represented by the operation signal from the switch section.

7. The pointing device according to claim 1, further comprising:
a display section which displays a video according to the video signal from the camera section and a pointer according to the moving vector.

8. A pointing method comprising:
receiving an operation signal from a switch section;
acquiring a video signal supplied from the camera section at first time represented by timing of the operation signal and a video signal supplied from the camera section at second time different from the first time represented by the operation signal;
comparing the video signal at the first time with the video signal at the second time so as to detect a moving vector showing a shift between the video at the first time and the video at the second time; and
treating the moving vector as a pointer signal on a screen of the video signal.

9. The pointing method according to claim 8, wherein a track of the moving vector based on the comparison of the video signals is detected, and the track is treated as the pointer signal on the screen of the video signal.
